(19) United States
(12) Patent Application Publication
(10) Pub. No.: US 2025/0029292 A1
(43) Pub. Date: Jan. 23, 2025

(54) METHOD AND SYSTEM FOR GENERATING DENTAL PANORAMIC IMAGES WITH SHARPENED DEPICTION OF CLINICALLY RELEVANT, PATIENT-SPECIFIC PRE-SELECTED ANATOMICAL STRUCTURES

(71) Applicant: DENTSPLY SIRONA Inc., York, PA (US)

(72) Inventors: Susanne MAUR, Bensheim (DE); Tim BRAUN, Gross-Gerau (DE)

(73) Assignee: DENTSPLY SIRONA Inc., York, PA (US)

(21) Appl. No.: 18/714,600

(22) PCT Filed: Dec. 5, 2022
(86) PCT No.: PCT/EP2022/084412

§ 371 Date: May 30, 2024

(30) Foreign Application Priority Data
Dec. 17, 2021 (EP) 21215687.1

(51) Int. Cl. G06T 11/00; G06T 7/00

(52) U.S. Cl. CPC G06T 11/006; G06T 7/0012; G06T 2207/10081; G06T 2207/20084; G06T 2207/30036

(57) ABSTRACT

Reconstructing a panoramic image of a patient's dental regions, including: providing at least one initial panoramic image reconstructed by using a plurality of projectional images of the patient and an initial layer including the mapping points corresponding to the patient's dental regions, to be sharply depicted in the initial panoramic image further including: detecting one or more clinically relevant patient-specific pre-selected anatomical structures in the initial panoramic; computing, using the anatomical data and the initial panoramic image, a new layer which includes the clinically relevant patient-specific pre-selected anatomical structure to provide a sharper depiction of the clinically relevant patient-specific pre-selected anatomical structures in a new panoramic image to be reconstructed compared to the depiction of the clinically relevant patient-specific pre-selected anatomical structure in the initial panoramic image; and reconstructing the new panoramic image using the plurality of projectional images of the patient and the computed new layer.

The entire content of the priority application EP2215681.1 is hereby incorporated by reference to this international application under the provisions of the pct.

### TECHNICAL FIELD OF THE INVENTION

The present invention relates to computer-implemented methods and systems for medical tomography, more particularly to panoramic imaging of dental regions.

### BACKGROUND OF THE INVENTION

Dental panoramic images are generally used for dental diagnosis and treatment of patients. A typical x-ray system for dental panoramic imaging includes an x-ray generator and an x-ray detector that are rotated around a patient's head. The x-ray detector acquires a plurality of x-ray projections of the patient's dental regions during the rotation.

The panoramic image is reconstructed from the plurality of projection images by using reconstruction parameters which describe a layer containing the mapping points corresponding to the patient's dental regions that should be in focus, namely sharply depicted in the panoramic image. In general, default reconstruction parameters which describe a default layer are used to focus on the dental regions, especially the patient's jaw arch. The dental regions outside the default layer which contain anatomical parts the dentist is not interested in (such as the spine) are thus blurred, and their influence on the panoramic image is reduced.

Since variations can occur in each individual panoramic imaging, especially due to the position and orientation of the patient's anatomy during acquisition, it can happen that a panoramic image generated with default reconstruction parameters will not be perfectly focused on the region of interest. This can make the diagnosis and treatment based on the panoramic image inaccurate and difficult.

Sometimes, it is possible to manually adjust the focus of the panoramic image by adjusting the position/orientation of the patient or by selecting one of the preset imaging programs that matches the patient's anatomy e.g., jaw width or size better than the other imaging programs. However, this can increase the manual effort required to adjust the patient and select the program, and may lead to multiple exposures.

In addition to the manual approaches, certain automatic approaches to improving image quality are also known, in which the focus of the panoramic image is adjusted after the projection images are acquired.

Auto-focus methods are already known which attempt to automatically optimize the sharpness of the resulting panoramic image for a given set of projection images by adjusting the reconstruction parameters. These methods use a mathematical metric, e.g., a measure of sharpness during image processing, which can be calculated for a reconstructed panoramic image, and then optimize the value of this metric by adjusting the reconstruction parameters, often in an iterative, gradient-descent type of numerical optimization. This procedure results in panoramic images that have an optimal measure of sharpness in a mathematical sense, but are not necessarily optimal for diagnostic use because the structures in focus do not always correspond the specific dental structures that are relevant for the dentist and the patient's clinical condition.

For example, in a patient with metal brackets these metric-optimizing autofocus methods automatically calculate a large increase in sharpness measure when focus is optimized on the high-contrast metal contours of the metal brackets. As a result, the sharpness improvement of the metal brackets will dominate the possible sharpness improvement on the diagnostically much more relevant teeth structures close to the metal brackets, which are less pronounced in terms of radiopaque contrast. In these cases, the auto-focus methods can reduce the image quality from a diagnostic point of view.

Reference is made to EP3685752A1 which discloses a method for producing a panoramic image of the oral cavity.

### DISCLOSURE OF THE INVENTION

The inventors have recognized that there is a need for an improved technique that allows automatic optimized reconstruction of a panoramic image in which a clinically relevant patient-specific pre-selected anatomical structure can be displayed more sharply without being disturbed by non-relevant structures.

The inventors are currently not aware of any technique that enables targeted adaptive improvement of the sharpness of only desired or pre-selected anatomical structures in a panoramic image by corresponding adjustment of the reconstruction parameters, namely the sharp layer.

An objective of the present invention is to provide a method and system for generating panoramic images with sharper depiction of clinically relevant patient-specific pre-selected anatomical structures desired for viewing by a dentist.

This objective has been achieved by the method as defined in claim 1, and the system as defined in claim 7. The subject-matters of the dependent claims relate to further developments and preferred embodiments.

The present invention provides a computer-implemented method for reconstructing a panoramic image of a patient's dental region. The method comprises a step of providing at least one initial panoramic image reconstructed by using a plurality of projectional images of the patient and an initial layer including the mapping points corresponding to the patient's dental regions, to be sharply depicted in the initial panoramic image. The method further comprises: a step of detecting one or more clinically relevant patient-specific pre-selected anatomical structures in the initial panoramic image in order to provide anatomical data relating to the spatial characteristics of the detected clinically relevant patient-specific pre-selected anatomical structures respectively; a step of computing, using the anatomical data and the initial panoramic image, a new layer which includes the clinically relevant patient-specific pre-selected anatomical structure in order to provide a sharper depiction of the clinically relevant patient-specific pre-selected anatomical structures in a new panoramic image to be reconstructed compared to the depiction of the clinically relevant patient-specific pre-selected anatomical structure in the initial panoramic image; and a step of reconstructing the new panoramic image using the plurality of projectional images of the patient and the computed new layer.

A major advantageous effect of the present invention is that new panoramic image can achieve a higher clinical value with respect to the anatomically or pathologically relevant structures.

Another major advantageous effect of the present invention is that the panoramic image can be generated automatically by focusing on one or more of the clinically relevant patient-specific pre-selected anatomical structures to be viewed by a dentist. The present method thus enables automatic adjustment of the sharp layer in the panoramic image by optimally determining the new reconstruction parameters which will be used for reconstructing the new panoramic image. The sharp layer in this context refers to the layer which includes the mapping points corresponding to the patient, to be depicted sharply in the panoramic image. More specifically, the present method enables adapting the depth of the sharp layer for multiple regions, and preferably each region, of the reconstructed panoramic image so that a panoramic image with the one or more regions including the clinically relevant patient-specific pre-selected anatomical structures of interest can be sharply depicted. By focusing on the clinically relevant patient-specific pre-selected anatomical structures, less computation is required compared to the conventional autofocus methods, and thus a faster computation can be achieved.

For comparison, known autofocus methods are likely to focus on bracket borders of a dental brace as this gives high sharpness metric values. However, the method of the present invention can ignore the bracket borders and can focus on the more important clinically relevant patient-specific pre-selected anatomical structures such as the tooth behind the bracket border. More specifically, the initial panoramic images serve as a reference. Based on the anatomical data, the new reconstruction parameters can be computed. Thus, the initial panoramic image(s) are used as a reference to locate the pre-selected anatomical structures and to determine the depth of the pre-selected anatomical structures in order to obtain the new layer. The present technique allows automatic computation of new reconstruction parameters which enable the clinically relevant patient-specific pre-selected anatomical structures to be included in the sharp layer of the panoramic image.

For comparison, known autofocus methods optimize an image quality metric like the local sharpness without considering the relevance of the depicted pre-selected anatomical structures. In the method of the present invention, however, the automatic predetermination of relevant anatomical or pathological structures of the patient's anatomy, prioritizes the focus optimization for these pre-selected anatomical structures over optimization of nearby prominent, but diagnostically non-relevant structures. Since only one depth layer can be depicted sharply in the reconstructed panoramic image, this avoids compromises in diagnostic quality for image regions where parameter optimization has to choose between focusing relevant and non-relevant features.

Herein, the anatomical structure refer to the class of a part or a specific part of the patient's oral anatomy. For example, an anatomical structure can be related to a group of teeth or a specific tooth, intraoral structures such as, dentition, gingiva, nerve channels, extraction sites, jaw bones, or extraoral structures such as condyles, nasal antrum, sinuses, and bones. Anatomical structures can be artificial structures such as dental replacements, e.g., dental crowns, braces, veneers, bridges. An anatomical structure can be an implant, or other natural or artificial structure attached to the jaw of the patient. An anatomical structure can relate to a patient's pathology or condition. As non-exhaustive examples, the pathology or the condition may be a fracture of tooth or bone, bone loss, caries, radiolucency, demineralization, infection, impaction, cyst, cancer or any other identifiable state of the oral anatomy or any part thereof.

In an embodiment, the clinically relevant patient-specific pre-selected anatomical structures are detected through segmentation operation. Alternatively, a localization operation can be performed. In an embodiment, the clinically relevant patient-specific pre-selected anatomical structures to be detected can be pre-selected by a user through input, for example by using a display, keyboard, or mouse. The user input may comprise one or more of the following: a list of anatomical structures related to classes or instances of parts of the patient's oral anatomy that are to be detected, such as tooth, tooth with a specific tooth number, or radiolucent lesion. This allows the dentist to improve the sharpness of the pre-selected anatomical structures in accordance with the diagnosis and therapeutical treatment relevant to the patient. The dentist can perform the pre-selection in accordance with the medical indication leading to the x-ray acquisition. Alternatively, the dentist can perform the pre-selection after previewing the initial panoramic images and forming a diagnostical interest to focus on specific anatomical structures.

In an embodiment, one or more of the computation step, the detection step and the reconstruction step is performed by a corresponding trained artificial neural network. A single artificial neural network can be also used. Alternatively, any of the computation step, the detection step and the reconstruction step can be performed without using an artificial neural network. The artificial neural network may comprise a convolutional neural network (“CNN”) with a plurality of processing layers arranged in serial and/or parallel configuration.

In an embodiment, the artificial neural network which is assigned to the detection step can be trained in a supervised manner using a plurality of input and output data pairs, each comprising: a panoramic image; and associated anatomical data for the anatomical structures that can be pre-selected.

In an embodiment, the artificial neural network which is assigned to the computing step can be trained in a supervised manner using a plurality of input and output data pairs, each comprising: a panoramic image with associated anatomical data; and an associated sharp layer.

In an embodiment, the artificial neural network which is assigned to the combined detection and computing steps can be trained in a supervised manner using a plurality of input and output data pairs, each comprising: a panoramic image; and an associated sharp layer.

In an embodiment, the artificial neural network which is assigned to the combined detection, computing and reconstruction steps can be trained in a supervised manner using a plurality of input and output data pairs, each comprising: projectional images, and an associated reconstructed panoramic image.

In an embodiment, the artificial neural network can be trained for the segmentation operation and/or the localization operation for the detection step.

### BRIEF DESCRIPTION OF THE DRAWINGS

In the following description, the present invention will be explained in more detail with reference to the exemplary embodiments and with reference to the drawings, wherein.

FIG. 1—shows a flowchart according to an embodiment of the present invention;

FIG. 2—shows a panoramic image with annotations of anatomical data;

FIGS. 3A-3D—shows the dependence of the panoramic images on patient position orientation;

FIG. 4—shows a flowchart according to a further embodiment of the present invention.

### SHARPENED DEPICTION OF CLINICALLY RELEVANT PATIENT-SPECIFIC PRE-SELECTED ANATOMICAL STRUCTURES

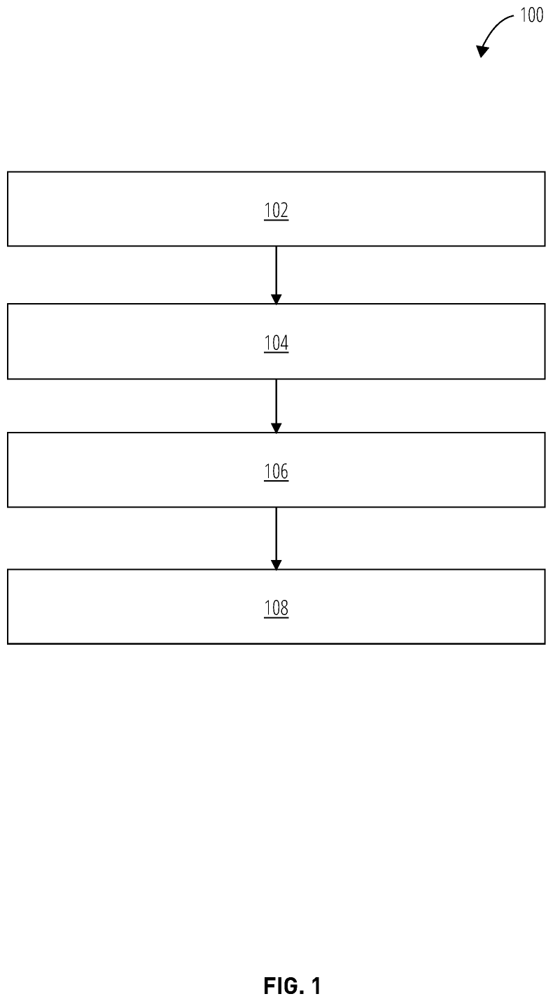

The flowchart (100) as shown in FIG. 1 can be implemented as a program executable by a computing means, for example, connected to an x-ray system, for example, a CBCT system or the like for dental applications.

In step (102), one or more initial panoramic images are provided. Each of the initial panoramic images is reconstructed from a plurality of projectional images that have been acquired during a panoramic imaging performed by the x-ray system. Each of the initial panoramic images is reconstructed using corresponding initial reconstruction parameters, which typically differs from those for the other initial panoramic images. The initial reconstruction parameters, namely the initial layer's spatial relationship for instance with respect to the trajectory of the x-ray generator (304) and its corresponding x-ray detector (306), and with respect to a bite block (not shown) and/or a head fixation (not shown) for positioning the patient is pre known. The initial reconstruction parameters can be derived from the acquisition geometry or from a defined layer in 3d space, or specified through default values.

In step (104), one or more clinically relevant patient-specific pre-selected anatomical structures are detected, preferably by an artificial neural network, in at least one of the initial panoramic images to provide anatomical data. The clinically relevant patient-specific pre-selected anatomical structures are detected through a segmentation operation. Alternatively, a localization operation can be performed.

The provided anatomical data describes the spatial relationship of the pre-selected anatomical structures in the panoramic imaging. As a few non-exhaustive examples, the anatomical data may comprise a standardized tooth number of a tooth, shape information of one or more teeth outlines, location of a tooth's pulpal chamber, location of a tooth tip, or any other anatomical information derivable from the initial panoramic image(s). The anatomical data may comprise information related to the jaw section or other parts of the oral anatomy or its surroundings, e.g., mandible, maxilla, gingiva, tooth root, nasal antrum, sinuses, condyles, etc.

If the anatomical data is depicted sufficiently sharp in at least one of the initial panoramic images, their rough position in 3D space, namely their focus depth, can be derived by back-projection using the layer showing the sharp depiction. The detection step can be performed by exploiting more than one initial panoramic images simultaneously.

In step (106), using the provided anatomical data and one or more initial panoramic images, new reconstruction parameters, namely a new (adjusted) layer is computed. The provided anatomical data includes spatial information about the detected clinically relevant patient-specific dental structures. The new reconstruction parameters are computed for providing appropriate focus depths which provide a sharper depiction of the clinically relevant patient-specific anatomical features, e.g., as compared to the depiction of the said structures in the initial panoramic images. The computation is preferably performed by the artificial neural network.

One or more further constraints may be considered when computing new reconstruction parameters, e.g., preferring a smooth layer in 3d space or weighting the clinically relevant patient-specific pre-selected anatomical structures in conflicting image regions.

Computing the new reconstruction parameters which provide appropriate focus depths and provide a sharper depiction of the clinically relevant patient-specific anatomical features can be realized in several ways:

In an embodiment the new reconstruction parameters are computed by varying the reconstruction parameters such that the sharpness of edges, contours and/or the contrast of the clinically relevant patient-specific pre-selected anatomical structures are optimal in the new panoramic image.

In another embodiment the new reconstruction parameters are computed by detecting the regions of the clinically relevant patient-specific pre-selected anatomical structures in the panoramic image and varying the reconstruction parameters such that the local sharpness of edges, contours and/or the contrast of any structures in these regions are optimal in the new panoramic image.

In another embodiment the new reconstruction parameters are computed by back-projecting the anatomical data to their positions in 3D space. These positions of the detected clinically relevant patient-specific pre-selected anatomical structures in 3D space can be used to compute the position of the sharp layer. Subsequently, a fine adjustment of the new reconstruction parameters can be computed by optimizing the local sharpness of edges or by optimizing the contrast by varying the reconstruction parameters in a small range.

The contrast or sharpness of structures other than the clinically relevant patient-specific pre-selected anatomical structures can decrease when the new reconstruction parameters are applied during reconstruction of the panoramic image.

In step (108), a panoramic image is reconstructed by using the new reconstruction parameters. The panoramic image depicts the clinically relevant patient-specific anatomical features in its sharp new layer.

The panoramic image reconstruction can be done by a weighted combination of pixels of the projectional images to form a reconstructed new panoramic image. Reconstruction parameters define the exact mathematical way in which the projectional images are combined by specifying a) which pixels in the projectional images are to be combined to a pixel in the reconstructed image and b) how they are weighted during combination.

In an embodiment, the clinically relevant patient-specific pre-selected anatomical structures to be detected can be input by a user, for example by using an input means (not shown) such as display, keyboard, or mouse. This allows the dentist to adapt the pre-selection of anatomical structures which are sharpened in accordance with the diagnosis and therapeutical treatment that is relevant for the patient.

### Trained Artificial Neural Network

In an embodiment, one or more of the computation step (104), the detection step (106) and the reconstruction step (108) are performed by the trained artificial neural network.

Alternatively, these can be performed without using any artificial neural network.

The artificial neural network for the detection step can be trained in a supervised manner using a plurality of data pairs, each including: a previous panoramic image; and associated anatomical data.

The artificial neural network for the computing step can be trained in a supervised manner using a plurality of data pairs, each including: a previous panoramic image provided with associated anatomical data; and an associated sharp layer.

The artificial neural network can be further trained for the segmentation operation and localization operations applied in the detection step.

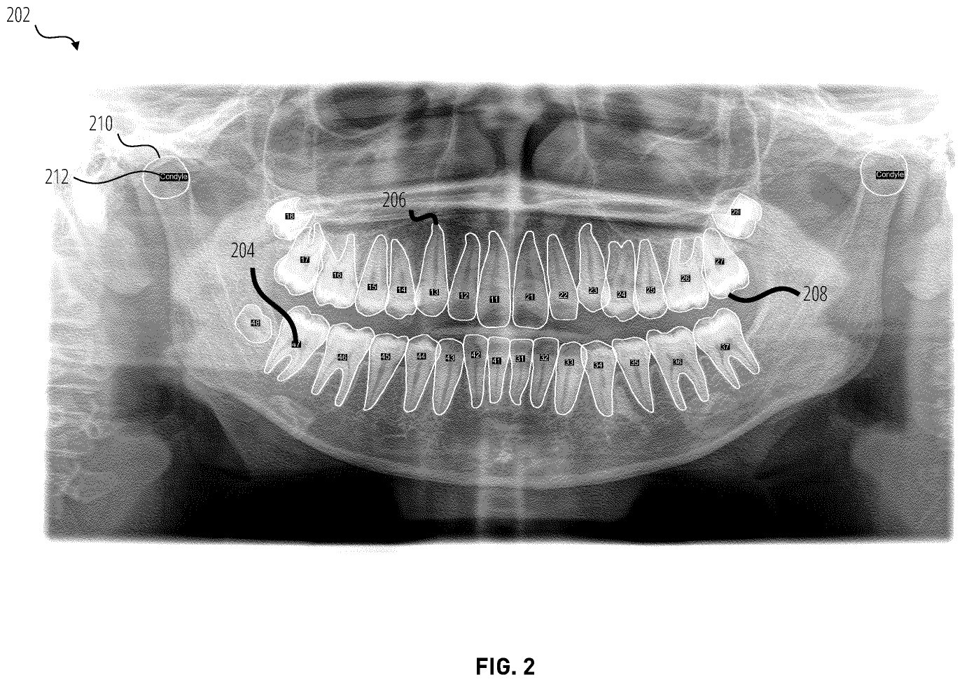

FIG. 2 shows an example of a panoramic image (202) which can be used in the training, and which has annotations showing pre-selected anatomical structures (204; 206; 208; 210; 212) such as teeth and condyles.

The panoramic image shows anatomical data overlaid to the initial panoramic image. A plurality of outlines or boundaries around different teeth as well as other pre-selected anatomical structures such as condyles are shown. Such boundaries or outlines can be obtained by segmentation operations. In FIG. 2, for example, a condyle boundary (210) is shown. Furthermore, a condyle localization (212) is shown as a dot or a point in the area where the respective condyle was detected by the artificial neural network. FIG. 2 shows boundaries (206.208) associated with the detected teeth in the panoramic image. FIG. 2 also shows a tag (204) associated with the detected tooth in the panoramic image.

### Patient's Misalignment

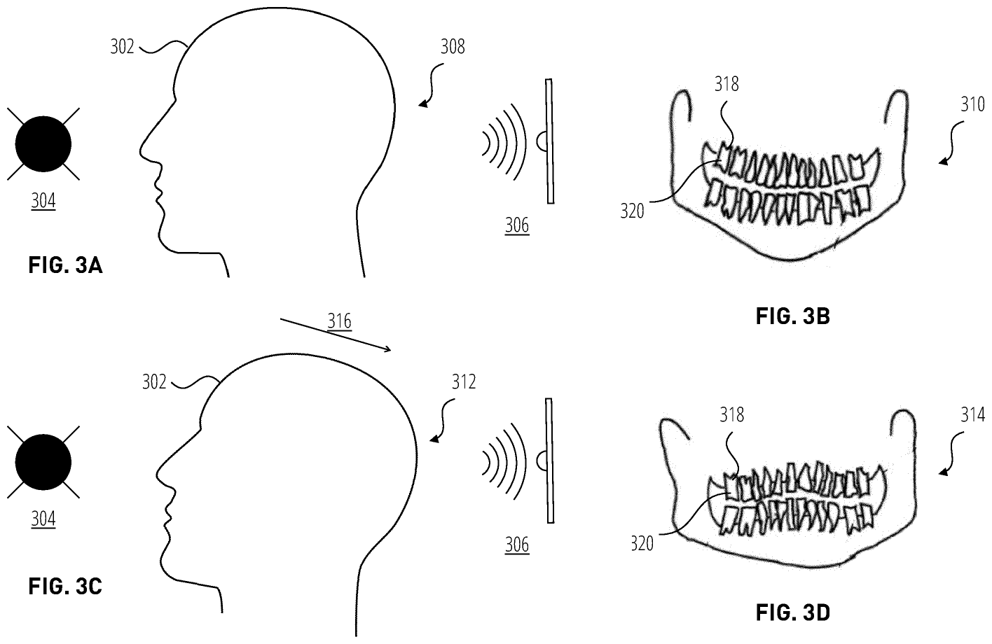

FIG. 3A-FIG. 3D illustrate the dependence of the panoramic images to a patient's position and orientation. FIG. 3A illustrates a first posture (308) of the head (302) of a patient with respect to an x-ray generator (304) and its corresponding x-ray detector (306). The first posture (308) may be considered an optimal posture. When the head (302) is scanned from the first posture (308), a panoramic image is generated which shows a corresponding first view (310) of the oral cavity. The first view (310) may be considered as correctly aligned view of the panoramic image. As can be seen, several anatomical structures such as tooth (320) and tooth root (318) are visible in the panoramic image.

In some cases, it may happen that the head (302) is not optimally positioned or aligned. For example, FIG. 3C shows a case where the head (302) is tilted backwards in a direction (316), with respect to the x-ray source (304) and x-ray detector (306) arrangement. In such a case, the patient's posture related distortion will be introduced in the resulting panoramic image. This can be seen in the corresponding panoramic image shown in FIG. 3D, which is a corresponding second view (314). As can be seen, unlike the first view (310), the second view (314) does not display the tooth row with a slightly upward curved curve, but rather somewhat resembling an s-shaped curve. Such posture related distortion can make it difficult to compare different panoramic images.

Accordingly, the present method also provides a technique to adjust the second view (314) such that it becomes identical or similar to the first view (310). This is achieved by computing, using the anatomical data, at least some of the new reconstruction parameters, whereby the new reconstruction parameters are adjusted to align the initial panoramic images with respect to a reference template defining an optima view. This adjustment is preferably performed by the artificial neural network.

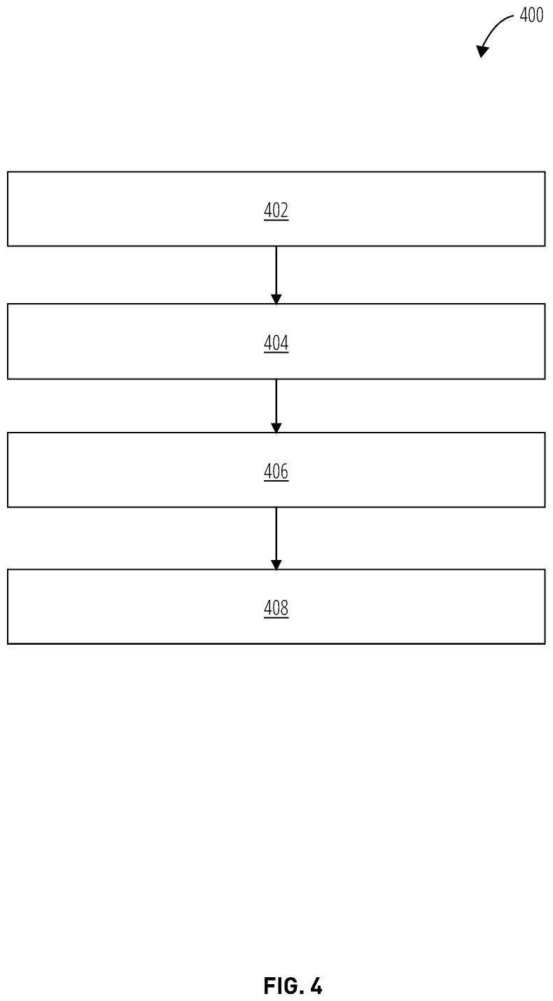

FIG. 4 shows a flowchart (400) according to a further embodiment of the present invention. The flowchart (400) can be implemented as a program executable by the computing means, for example, connected to the x-ray system, for example, a CBCT system or the like for dental applications. The flowchart (400) and flowchart (100) can be executed by the same computing means or different ones.

In step (402), one or more initial panoramic images are provided. Each of the initial panoramic images is reconstructed from a plurality of projectional images that have been acquired by the x-ray system. Each of the initial panoramic images is reconstructed using initial reconstruction parameters, which may be identical or non-identical to those for the other initial panoramic images.

In step (404), one or more clinically relevant patient-specific anatomical structures are detected, preferably via the artificial neural network in at least one of the initial panoramic images to provide anatomical data.

In step (406), using the provided anatomical data and one or more initial panoramic images, a plurality of new reconstruction parameters is computed. The new reconstruction parameters are computed for aligning projection of the panoramic image with respect to the reference template. The computation is preferably performed by the artificial neural network.

In step (408), a panoramic image is reconstructed using the new reconstruction parameters. The panoramic image thus provides an aligned view. When combined with the flowchart (100), the present technique can simultaneously provide the panoramic image with clinically relevant patient-specific pre-selected anatomical structures in the sharp layer as well as in the aligned view.

1. A computer-implemented method of reconstructing a panoramic image of a patient's dental regions, comprising:
providing at least one initial panoramic image reconstructed by using a plurality of projectional images of a patient and an initial layer including the mapping points corresponding to the patient's dental regions, to be sharply depicted in the initial panoramic image,
detecting one or more clinically relevant patient-specific pre-selected anatomical structures in the initial panoramic image to provide anatomical data relating to the spatial characteristics of the detected clinically relevant patient-specific pre-selected anatomical structures respectively;
computing, using the anatomical data and the initial panoramic image, a new layer which includes the clinically relevant patient-specific pre-selected anatomical structure to provide a sharper depiction of the clinically relevant patient-specific pre-selected anatomical structures in a new panoramic image to be reconstructed compared to the depiction of the clinically relevant patient-specific pre-selected anatomical structure in the initial panoramic image; and
reconstructing the new panoramic image using the plurality of projectional images of the patient and the computed new layer.

2. The method according to claim 1, wherein the clinically relevant patient-specific pre-selected anatomical structures to be detected are input by a user.

3. The method according to claim 1, wherein one or more of the computing, the detecting and the reconstructing are performed by a trained artificial neural network.

4. The method according to claim 3, wherein an trained artificial neural network assigned to the detecting is trained in a supervised manner using a plurality of input and output data pairs, each comprising: a panoramic image; and associated anatomical data.

5. The method according to claim 3, wherein an artificial neural network assigned to the computing is trained in a supervised manner using a plurality of input and output data pairs, each comprising: a panoramic image with associated anatomical data; and an associated sharp layer.

6. The method according to claim 3, wherein an artificial neural network assigned to a combined detecting and computing is trained in a supervised manner using a plurality of input and output data pairs, each comprising: a panoramic image; and an associated sharp layer.

7. The method according to claim 3, wherein an artificial neural network assigned to a combined detecting, computing and reconstructing is trained in a supervised manner using a plurality of input and output data pairs, each comprising:
a plurality of projectional images; and an associated reconstructed panoramic image.

8. A non-transitory computer-readable storage medium, the computer-readable storage medium including instructions that when executed by a computer, cause the computer to:
provide at least one initial panoramic image reconstructed by using a plurality of projectional images of a patient and an initial layer including the mapping points corresponding to a patient's dental regions, to be sharply depicted in the initial panoramic image,
detect one or more clinically relevant patient-specific pre-selected anatomical structures in the initial panoramic image to provide anatomical data relating to the spatial characteristics of the detected clinically relevant patient-specific pre-selected anatomical structures respectively;
compute, using the anatomical data and the initial panoramic image, a new layer which includes the clinically relevant patient-specific pre-selected anatomical structure to provide a sharper depiction of the clinically relevant patient-specific pre-selected anatomical structures in a new panoramic image to be reconstructed compared to the depiction of the clinically relevant patient-specific pre-selected anatomical structure in the initial panoramic image; and
reconstruct the new panoramic image using the plurality of projectional images of the patient and the computed new layer.

9. A computerized x-ray system for reconstructing a panoramic image, comprising program instructions which when executed by the computerized x-ray system cause the computerized x-ray system to:
provide at least one initial panoramic image reconstructed by using a plurality of projectional images of a patient and an initial layer including the mapping points corresponding to a patient's dental regions, to be sharply depicted in the initial panoramic image,
detect one or more clinically relevant patient-specific pre-selected anatomical structures in the initial panoramic image to provide anatomical data relating to the spatial characteristics of the detected clinically relevant patient-specific pre-selected anatomical structures respectively;
compute, using the anatomical data and the initial panoramic image, a new layer which includes the clinically relevant patient-specific pre-selected anatomical structure to provide a sharper depiction of the clinically relevant patient-specific pre-selected anatomical structures in a new panoramic image to be reconstructed compared to the depiction of the clinically relevant patient-specific pre-selected anatomical structure in the initial panoramic image; and
reconstruct the new panoramic image using the plurality of projectional images of the patient and the computed new layer.
